(19) United States
(12) Patent Application Publication
(10) Pub. No.: US 2017/0124586 A1
(43) Pub. Date: May 4, 2017

(54) SYSTEMS AND METHODS FOR PROVIDING A PERSONALIZED PREPAID CARD

(71) Applicant: Referral Rewards LLC, Woodridge, IL (US)

(72) Inventors: Mark Tepper, Woodridge, IL (US); John Boldebuck, Woodridge, IL (US)

(21) Appl. No.: 15/337,954

(22) Filed: Oct. 28, 2016

Related U.S. Application Data
(60) Provisional application No. 62/248,590, filed on Oct. 30, 2015.

(51) Int. Cl. G06Q 30/02; G06Q 30/06; G06Q 20/34

(52) U.S. Cl. CPC G06Q 30/0217; G06Q 30/0225; G06Q 20/342; G06Q 30/0621

(57) ABSTRACT

Systems and methods are provided for providing a personalized prepaid card by receiving a user selection for designing a user-customized product and generating a first image of a personalized prepaid card having an image of the user-customized product, whereby the personalized prepaid card image is delivered to the user with an offer to receive the card in exchange for satisfying one or more conditions associated with the offer and providing the user with a unique identifier code associated with the offer to present the code to a retail establishment selling the user-customized product for activating the personalized prepaid card.

### CROSS-REFERENCE TO RELATED APPLICATIONS

This application claims priority to U.S. Provisional Application No. 62/248,590, which was filed on Oct. 30, 2015 and is incorporated by reference herein in its entirety.

### TECHNICAL FIELD

This invention relates to systems and methods for providing a personalized prepaid card.

### BACKGROUND OF THE INVENTION

Businesses use various forms of advertising to reach consumers and increase prospective customer traffic to their websites, online stores, and/or physical retail establishments. Some businesses provide online tools or features that are designed to keep prospective customers on their websites longer, encourage more interest in the products offered by the websites, and/or to help consumers explore products in more detail, perhaps prior to, or in place of, visiting a physical retail establishment that sells the same products. For example, one existing online tool allows prospective customers to select features or options for building a customized product, and in some cases, request a quote or cost estimate for the customized product. This type of online tool can enable the consumer to become more familiar with the available customization options for a given product and, in some cases, have a better idea of what to expect or look for prior to visiting the physical retail establishment and seeing the product in person. However, at least with regard to products that cannot be bought immediately online, there is still a need for motivating persons that are interacting on a company's website traffic to visit in person the company's retail establishment.

Many businesses offer promotions or rewards designed to help convert prospective customers into purchasers—in-store, or online. One existing type of such an offer is through a prepaid card, which may be given to prospective customers in exchange for satisfying a predetermined condition, such as, for example, completing a customer survey, providing personal information, recommending a new customer, visiting a retail establishment, viewing an advertisement, or other condition designed to encourage new financial transactions. In some cases, the prepaid cards also serve as brand promotion tools. For example, a face of the prepaid card may be branded with a logo of the business entity offering the reward and/or issuing the card. In addition, the prepaid cards typically have a unique account number printed on the face of the cards. Other than these details, existing prepaid cards are typically not personalized with a particular consumer identity, as the cards are non-specific and only may include identification of the business entity. This provides the company complete flexibility with regard to distribution of the cards, and/or because the identity of the ultimate recipient is typically unknown at the time of printing the card.

### SUMMARY OF THE INVENTION

The invention is intended to resolve the above-noted needs with systems and methods for providing a personalized prepaid card that is designed to, among other things: (1) promote a user-configured product that has been customized by the card recipient using an online product customization tool, (2) display an image of the user-configured product on a face of the personalized prepaid card, (3) encourage an in-store visit to a retail establishment that may sell the user-configured product, and (4) obtain personal information about the card recipient for future marketing and/or targeted advertising purposes.

For example, one embodiment includes a method of providing a personalized prepaid card, the method comprising the steps of receiving one or more user selections for designing a user-customized product and, based on the received user selections, generating (using a processor) a first image of a personalized prepaid card with a second image of the user-customized product. The method further includes the step of sending, as a display on the client device, the first image and a user-selectable option for accepting an offer to receive the personalized prepaid card in exchange for satisfying one or more conditions associated with the offer. Upon receiving a user selection of the user-selectable option, providing to the user, a unique identifier code associated with the offer, and instructions to present the unique identifier code to a retail establishment selling the product upon satisfying the one or more conditions. Upon receiving the unique identifier code from a retail device associated with the retail establishment, a personalized prepaid card is made available, if the received unique identifier code is valid.

Another example embodiment provides a system for providing a personalized prepaid card, the system comprising: a remote server comprising a build-a-product module for enabling a user to select customizable options for designing a user-customized product; a client device associated with the user and communicatively coupled to the remote server for providing user selections defining the user-customized product to the remote server, wherein the remote server further comprises a card offer module for generating a first image of a personalized prepaid card comprising a second image of the user-customized product, the second image being based on the user selections received from the client device, the card offer module further for sending, to the client device for display thereon, the first image and a user-selectable option for accepting an offer to receive the personalized prepaid card in exchange for satisfying one or more conditions associated with the offer, the card offer module also for providing, to the user upon receiving a user selection of the user-selectable option, a unique identifier code associated with the offer and instructions to present the unique identifier code to a retail establishment selling the user-customized product upon satisfying the one or more conditions; and a retail device associated with the retail establishment and communicatively coupled to the remote server for providing, to the remote server, the unique identifier code received from the user, wherein the card offer module is further for activating the personalized prepaid card if the received unique identifier code is valid.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating an exemplary system for providing a personalized prepaid card in accordance with embodiments.

FIG. 2 is a flowchart illustrating example operations of the system of FIG. 1 in accordance with embodiments.

FIG. 3 is a flowchart illustrating example operations of the remote server of FIG. 1 in accordance with embodiments.

FIG. 4 is a block diagram of one form of a computer or server of FIG. 1, having a memory element with a computer readable medium for implementing example operations of FIGS. 2 and/or 3 in accordance with embodiments.

FIGS. 5-11, 14, and 15 illustrate example user interfaces for implementing example operations of FIGS. 2 and/or 3 in accordance with embodiments.

FIG. 12 illustrates an example personalized prepaid card in accordance with embodiments.

FIG. 13 illustrates an example paper mailer and an electronic message associated with an offer to receive the personalized prepaid card shown in FIG. 12, in accordance with embodiments.

### DETAILED DESCRIPTION OF THE INVENTION

The description that follows describes, illustrates, and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate an exemplary system including components for one or more of the embodiments contemplated herein, it should be understood that with respect to each embodiment, one or more components may not be present or necessary in the system.

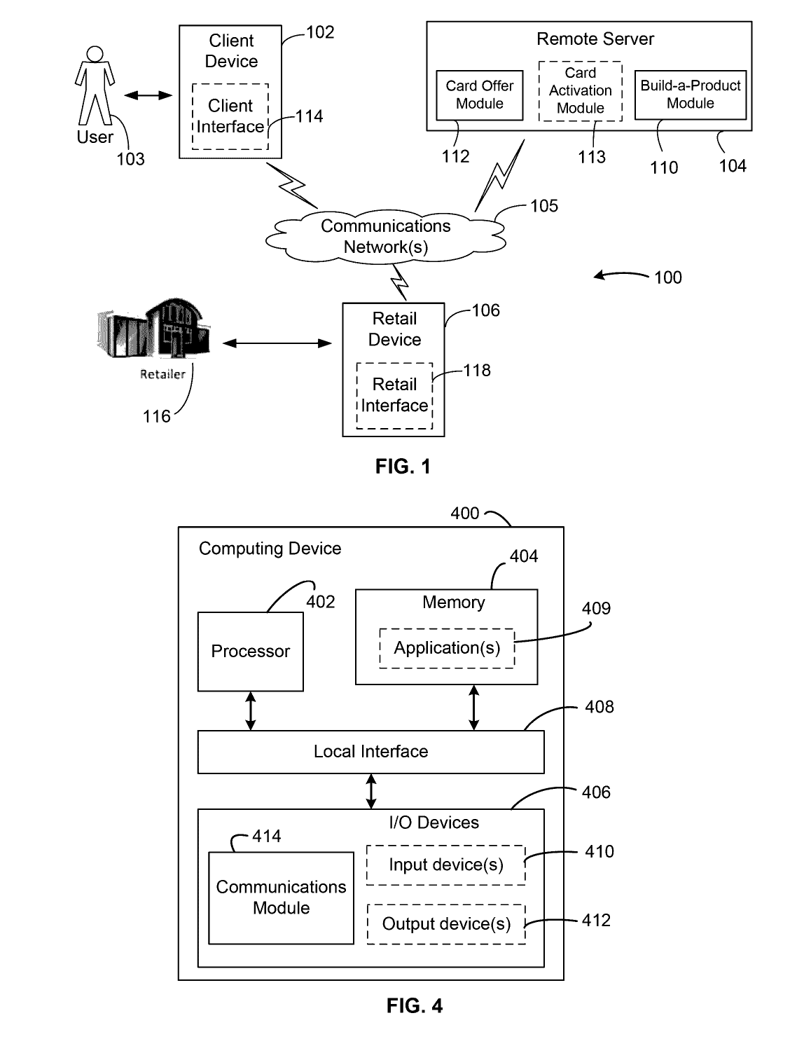

FIG. 1 illustrates a computer-networked system 100 for providing a personalized prepaid card to a user, in accordance with one or more embodiments. As shown, the system 100 includes a client device 102 operated by a user 103, a remote server 104 coupled to one or more communication networks 105, and a retail device 106 operated by an employee or other person associated with a retail establishment or retailer 116. The user 103 can be any person or entity that operates the client device 102 and in a preferred embodiment, is a prospective or existing customer of the retail establishment 116. The remote server 104 can be associated with (e.g., owned, operated, or controlled by) a manufacturer, dealer, distributor, retailer, or other business entity offering user-configurable products for sale, and in a preferred embodiment, is associated with the retail establishment 116. In embodiments, the remote server 104 can host a website advertising the user-configurable products, and the retail establishment 116 can be a physical store that displays and sells the user-configurable products advertised on the website. The user-configurable products can include, for example, but not limited to, automotive vehicles, bicycles, motorcycles, computers (e.g., laptops or desktops), tablets, smartphones, other personal electronic devices, audio systems, televisions, other household devices, or any other product that can be tested (or test-driven) before purchasing. As an example, in one embodiment, the user-configurable product is a car, the remote server 104 is affiliated with a manufacturer of the car, and the retail establishment 116 is a dealership that sells cars made by the manufacturer.

The client device 102 and the retail device 106 can be any type of computing device, including, for example, a laptop computer, a personal computer, a tablet, a smartphone, a personal data assistant, or the like. The client device 102 and the retail device 106 can be communicatively coupled to the remote server 104 through the communication network(s) 105 (such as, for example, the Internet) using one or more communication technologies, such as, for example, WiFi, Ethernet, cellular data, and satellite. According to embodiments, the remote server 104 can reside on a single remote computing device, or multiple, related remote computing devices that are connected by a network. In some embodiments, the remote server 104 is comprised of a distributed network of servers (also referred to herein as a “server network”), and each server, or a combination of select servers, can be configured to implement all or portions of the software modules or processes described herein.

As used herein, the terms “prepaid card” and “prepaid account” refer to any type of financial card or account that can have a preloaded or stored cash value and that may be used to make electronic payments for goods or services using that cash or monetary value. For example, the prepaid card can be used to make in-person purchases at merchant locations and/or online purchases at merchant websites. Examples of the prepaid card include gift cards, promotional value cards, rebate cards, cash cards, and stored-value cards (or accounts). In some instances, the prepaid card may be considered to be a debit card.

The prepaid card can be associated with any type of prepaid account, including for example, a closed system account that is issued by a particular merchant and usable only at that merchant's store(s) (e.g., store gift cards), a “semi-closed” system account that is issued by a third party and may be used at multiple merchants (e.g., mall gift cards), or an open system account that is linked to a payment network, such as VISA®, MasterCard®, DISCOVER®, or AMERICAN EXPRESS®, and may be used to make purchases at any merchant that accepts or is affiliated with the payment network (e.g., similar to a debit or credit card). Additionally, the prepaid card can be either “reloadable,” such that the card holder (e.g., the user 108) can load and reload funds onto the card, or “non-reloadable,” such that the card expires once the initial balance is completely depleted. In a preferred embodiment, the personalized prepaid card provided by the system 100 is associated with a non-reloadable, open system account.

In embodiments, the prepaid card is a “corporate-funded” card that can be loaded with a predetermined cash value by a business or corporate entity that is funding, offering, and/or distributing the card (e.g., the manufacturer of the user-configured product and/or the retail establishment 116 that sells the user-configured product). In some cases, the prepaid card may have an initial balance of zero, and the business entity that distributes the card can selectively load the card with a predetermined monetary amount, for example, once the terms of the offer have been met. In other cases, the prepaid card can be acquired by the business entity with a preloaded cash value (e.g., $25, $50, etc.). Data indicating a cash value of the prepaid card can be stored directly on the card, for example, in a memory chip included in the card or in a remote location (e.g., at a host computer) that can be accessed using information stored on an integrated circuit or magnetic strip included on the card. When the prepaid card is used to make a purchase, the data indicating the cash value of the prepaid card is updated to reflect the decrease in cash value.

The prepaid card may be embodied as a physical (typically plastic) prepaid card, a virtual prepaid card (e.g., an electronic prepaid card or “e-card”), a mobile payment device (e.g., included in a mobile wallet stored in a smartphone or other mobile device), or any other account transaction mechanism or device that can be used to make purchases. The prepaid card is associated with an account number that may be printed on a face of the card, if a physical prepaid card, displayed on a display screen presenting the prepaid card, if a virtual prepaid card, or stored in a memory associated with the prepaid card, if a mobile payment device. The prepaid card may also be associated, displayed, or printed with a name of an issuing bank, a logo of an affiliated payment network (e.g., VISA®, MasterCard®, etc.), a logo of the business entity funding the prepaid card (e.g., the product manufacturer, the retailer 116, etc.), and/or other information (e.g., a customer number, a verification number, etc.).

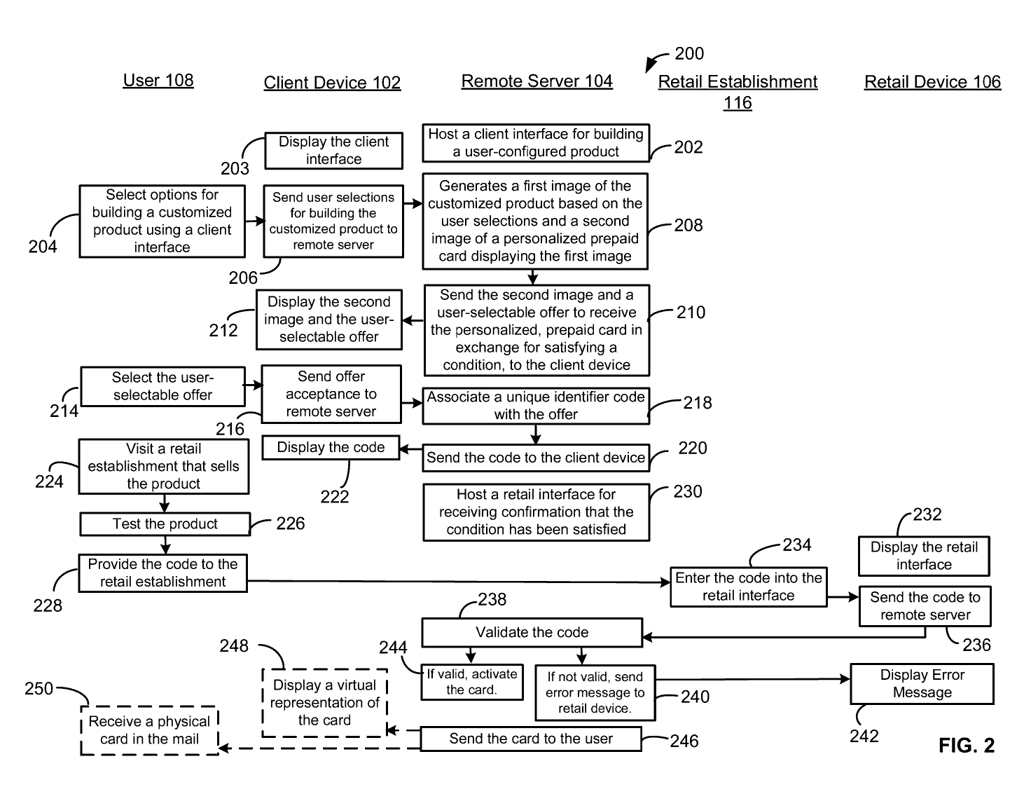

Various components of the system 100 may own, operate, control, or be otherwise affiliated with one or more computers (e.g., servers, personal computers, computing devices, mobile devices, etc.) that are configured to execute software for implementing the principles disclosed herein. An exemplary computing device 400 for executing such software is shown in FIG. 4 and will be discussed in more detail below. According to embodiments, FIG. 2 illustrates an exemplary process 200 for providing a personalized prepaid card that may be implemented using the system 100, or more specifically, through interactions between various components of the system 100 that are facilitated by software executing on the computer processors (not shown) associated with said components. In some cases, the software may reside on the remote server 104 and/or various interface devices (such as, e.g., the client device 102 and/or the retail device 106), for example, by being downloaded through the Internet or other network, or copied into memory on those devices through transport on a computer readable medium. Accordingly, the process 200 will be described in conjunction with a description of the various components of the system 100.

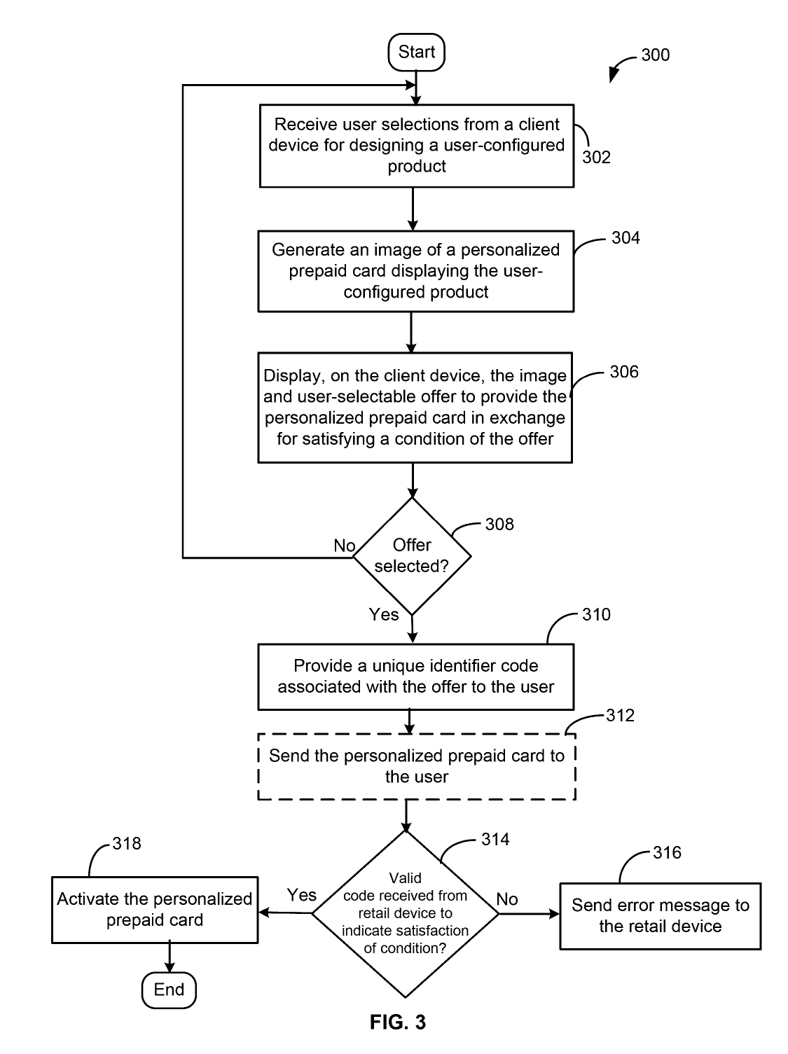

As shown in FIG. 1, the remote server 104 includes a build-a-product module 110 and a card offer module 112. The build-a-product module 110 comprises computer modules or software instructions for enabling the user 108 to design a customized product by selecting one or more customizable options, and to preview the customized product once the user selections are complete. The card offer module 112 comprises computer modules or software instructions for providing an offer for a personalized prepaid card to the user 108 upon determining that the user 108 has built a customized product using the build-a-product module 110. In embodiments, the card offer module 112 can be configured to carry out select portions of the process 200 (e.g., the operations performed by the remote server 104) and/or a process 300 shown in FIG. 3. Further, the build-a-product module 110 may be configured to communicate with the card offer module 112, for example, in order to provide user-configured product information to the card offer module 112 once the user 108 has customized a product through the build-a-product module 110. In some cases, the modules 110 and/or 112 include an applet or other small program that is executed from within an overall website associated with or operated by the product manufacturer in order to advertise its products.

In embodiments, the user 108 may interact with the build-a-product module 110, the card offer module 112, and/or the website hosted by the remote server 104 through a client interface 114. Likewise, a retailer or retail establishment 116 that sells the user-configured product may interact with the card offer module 112 and/or the remote server 104 through a retail interface 118. In one embodiment, the interfaces 114 and 118 may be software programs that are designed to operate on the respective interface devices 102 and 106 and are tailored to interact and exchange data with the build-a-product module 110, the card offer module 112 and/or the remote server 104.

In some cases, these software programs may include mobile applications that execute on smart phones, mobile devices, and the like, such as those with the iOS, Android, and Blackberry operating systems. In some embodiments, the interfaces 114 and 118 may reside only on the remote server 104. In other embodiments, the interfaces 114 and 118 may be standard web browser software programs, such as Internet Explorer, Firefox, Chrome, or Safari. In this case, the user 108 and/or the retail establishment 116 use the browser interface to interact with the build-a-product module 110 and/or the card offer module 112 in a web portal configuration.

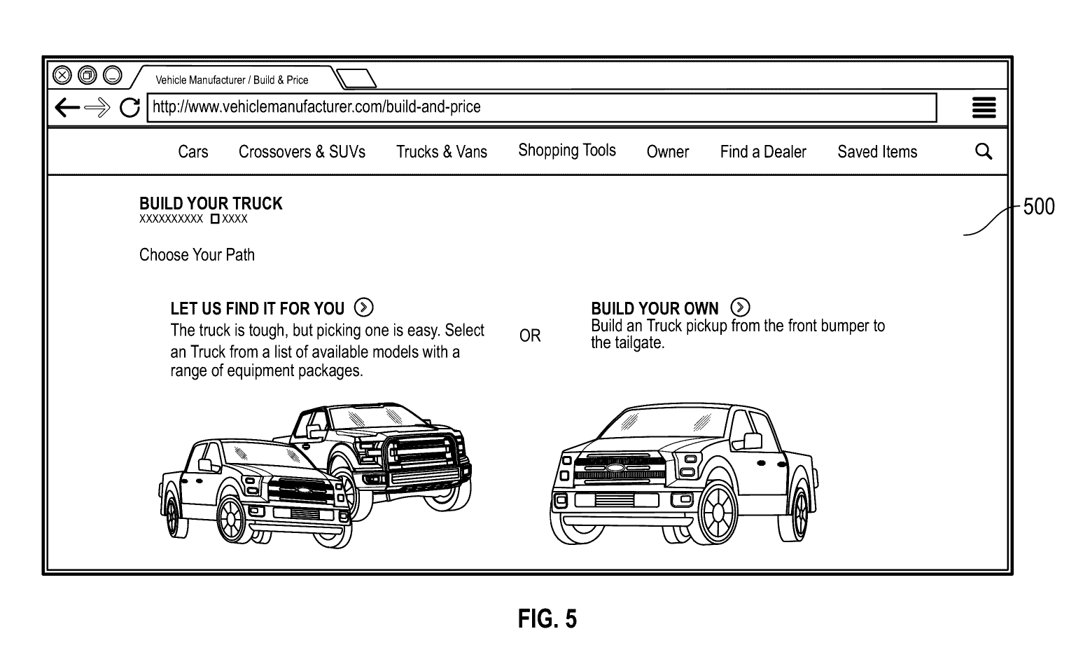

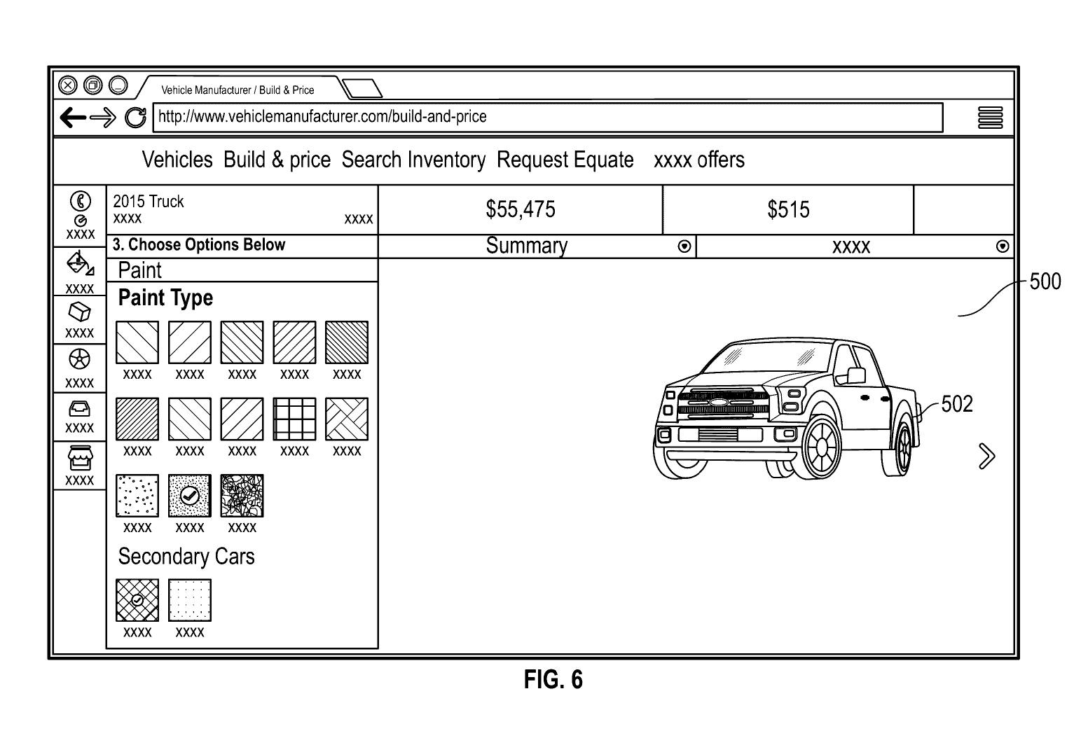

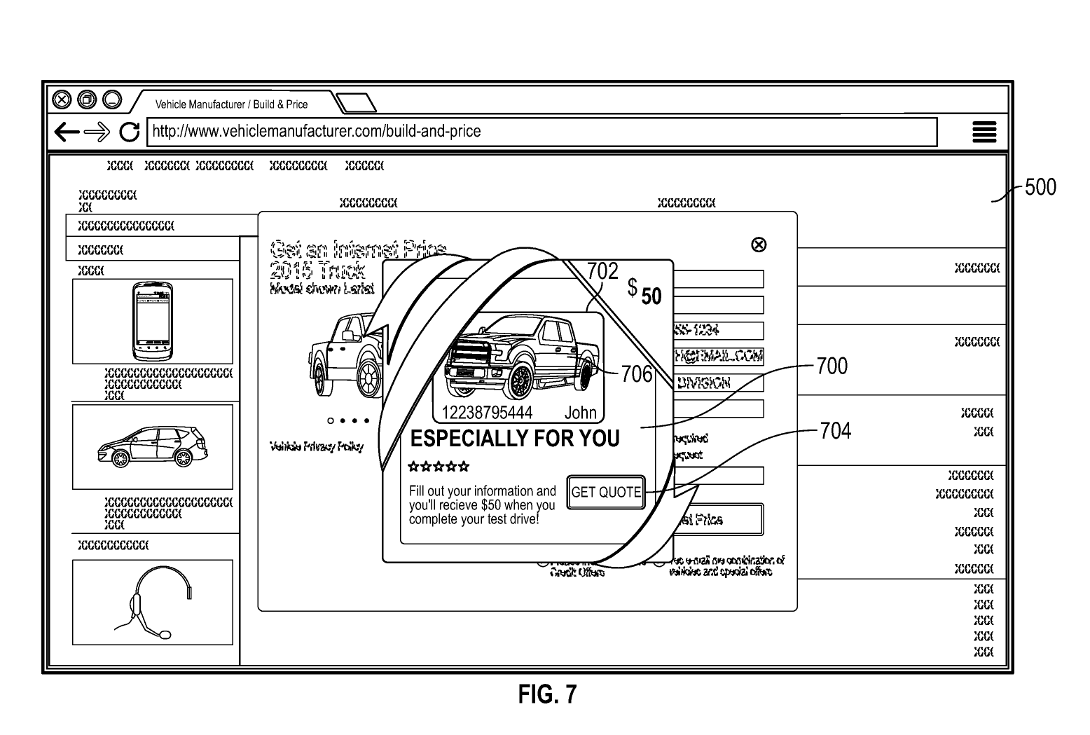

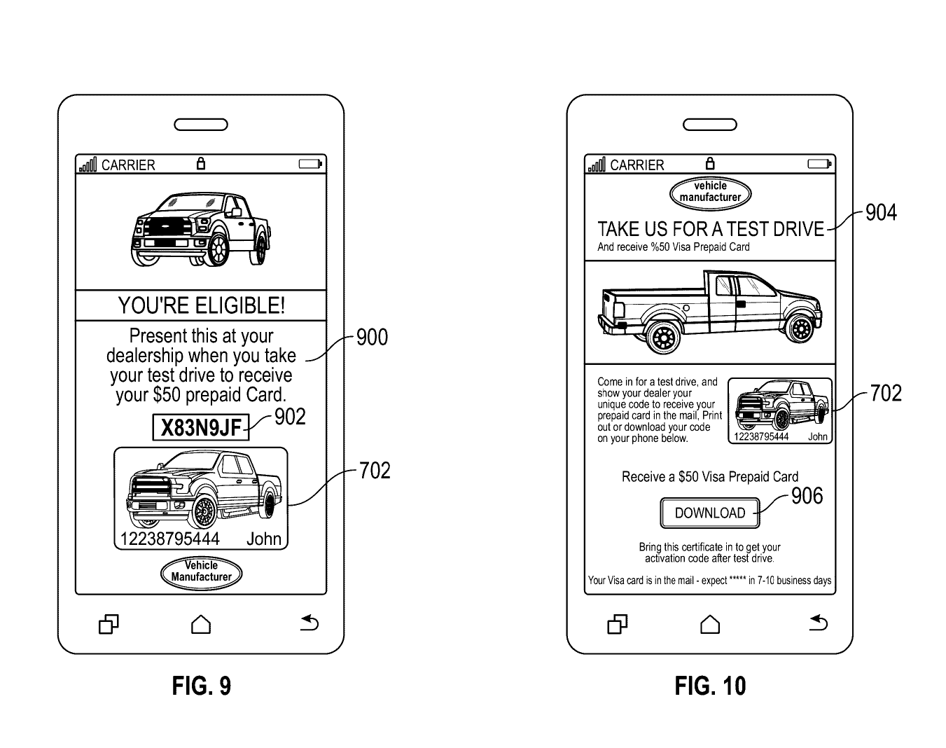

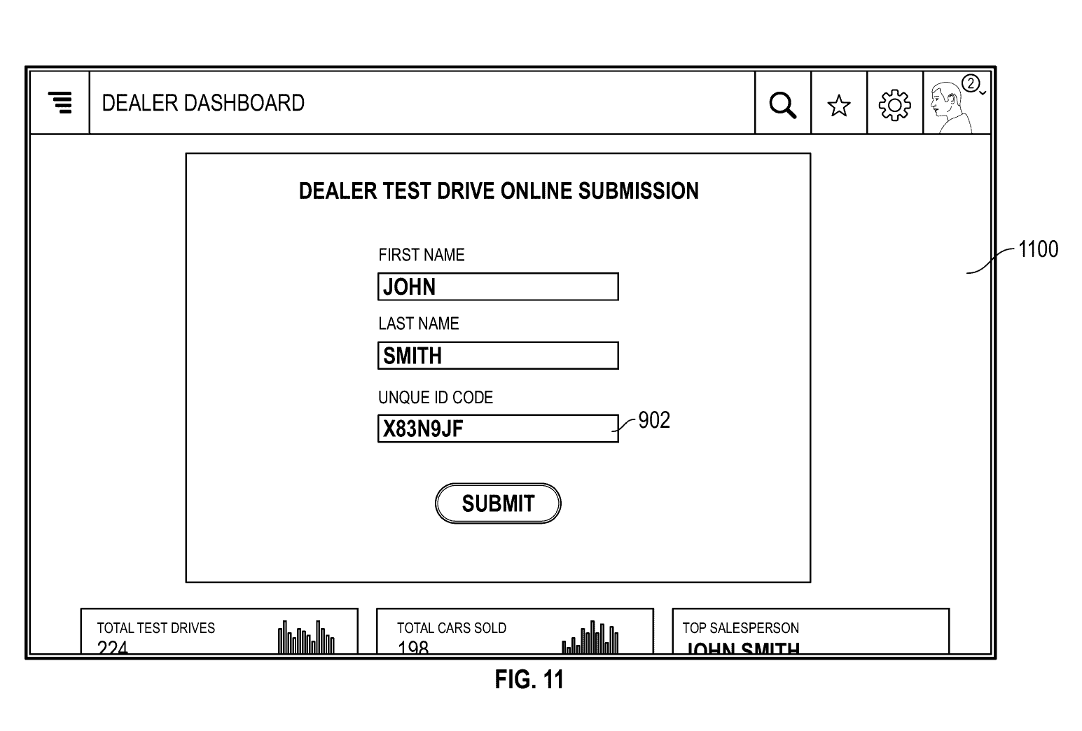

Exemplary screenshots of the client interface 114 as a mobile application executing the card offer module 112 are shown in FIGS. 9, 10, and 13. Exemplary screenshots of the client interface 114 as a browser application executing the build-a-product module 110 are shown in FIGS. 5 and 6. Exemplary screenshots of the client interface 114 as a browser application executing the card offer module 112 are shown in FIGS. 7, 8, 14, and 15. An exemplary screenshot of the retail interface 118 as a browser application executing the card offer module 112 is shown in FIG. 11. These screenshots in FIGS. 5-15 will be described in more detail in conjunction with a description of the process 200.

Referring now to FIG. 2, the process 200 may begin at step 202 with the remote server 104 hosting a website 500 for enabling a user, or prospective customer, to build a user-configured or customized product 502, such as, for example, as shown in FIGS. 5 and 6. In embodiments, the website is executed, at least in part, by the build-a-product module 110 stored in the remote server 104, and the website is operated by or affiliated with a manufacturer of the product. The user 108 can access and interact with the website 500 through the client interface 114 which is displayed on the client device 102 at step 203. At step 204, the user 108 selects options for building the customized product 502 using the client interface 114. The user-selectable options can vary depending on the type of product. For example, in FIG. 6, the website 500 is hosted by a car manufacturer, and the customizable options for a given vehicle make and model may include exterior body paint, seat types and configuration, interior trim (fabric) type and color, engine size, tire type and size, stereo system, and other features, equipment, accessories, or add-ons. At step 206, the client device 102 sends the user-selected options for building the customized product 502 to the remote server 104.

At step 208, based on the user-selected options received from the client device 102, the remote server 208 generates a first image of the user-customized product 502 and a second image of a personalized prepaid card displaying the first image. In embodiments, the user-selected options can be provided to the build-a-product module 110 of the remote server 104 in order to generate the first image of the user-customized product 502 once the user 108 has completed the product building process. In one embodiment, the build-a-product module 110 can be configured to notify the card offer module 112 when the user has finished designing the customized product 502 and to provide the first image to the card offer module 112 thereafter. In another embodiment, the build-a-product module 110 can be configured to display a user-selectable option for obtaining a price quote for the user-customized product 502. Upon user selection of the quote option, the build-a-product module 110 notifies the card offer module 112 of the request and provides the first image to the card offer module 112. In either case, the card offer module 112 can be configured to generate the second image, which shows the personalized prepaid card with the first image of the user-customized product 502 on a face of the card.

At step 210, the remote server 104 sends, to the client device 102, the second image and a user-selectable option to accept an offer to receive the personalized prepaid card shown by the second image in exchange for satisfying at least one predetermined condition. At step 212, the client device 102 displays the second image and the user-selectable option to accept the offer via the client interface. At step 214, the user 108 selects the user-selectable option to accept the offer via the client interface 114. At step 216, upon receiving user selection of the option to accept, the client device 102 sends the offer acceptance to the remote server 104.

FIG. 7 shows an exemplary offer 700 that may be generated by the card offer module 112 upon receiving the first image from the build-a-product module 110. As shown, the card offer module 112 can be configured to present the offer 700 in a pop-up application window or other new application window (e.g., pop-under window, slide-in window, in-footer window, etc.) that overlays the website 500 or is otherwise presented without closing or exiting the existing website 500. The new window displays a card image 702 (e.g., the second image) showing the offered prepaid card, a “Get Quote” button 704 (e.g., the user-selectable option) for selecting or accepting the offer, a cash value of the offered prepaid card, and other textual information describing the terms or conditions of the offer 700. In embodiments, the card image 702 includes a product image 706 (e.g., the first image) that shows the product 502 exactly as built or customized by the user using the website 500 and/or the build-a-product module 110. In at least this manner, the offered prepaid card is personalized to the user 108, which may further incentivize the user 108 to accept the offer 700, in addition to the offered cash value. In embodiments, the card offer module 112 is configured to present the offer 700 in a pop-up or other new window that overlays the website 500 or is otherwise displayed on the client interface 114 before the user 108 can continue to a next page of the website 500 and/or before the remote server 104 and/or the build-a-product module 110 calculates a price quote for the user-customized product 502, so as to effectively capture the attention of the user 108 while still on the web site 500.

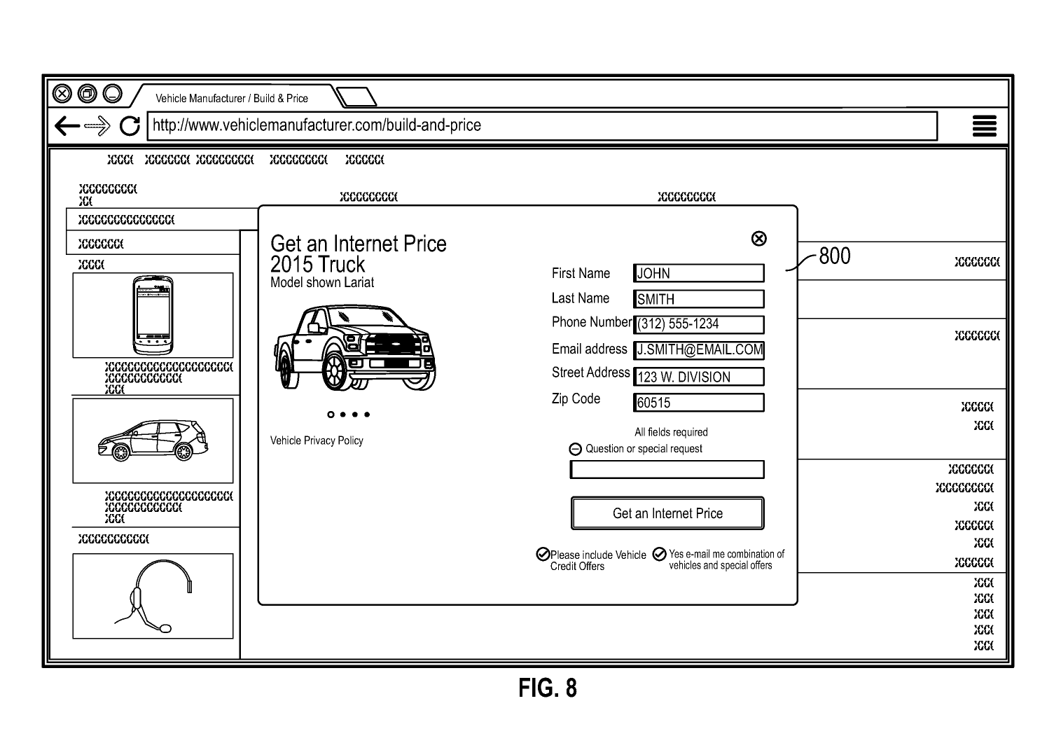

FIG. 8 shows an exemplary quote request window 800 that may be generated by the remote server 104 and/or the card offer module 112 and presented on the client interface 114 upon receiving user selection of the Get Quote button 704. As shown, the quote request window 800 prompts the user 108 to enter his/her personal information before a quote is generated or calculated. In some embodiments, entry of personal information is one of the predetermined conditions of the offer 700, or a pre-condition in order to be eligible to receive the prepaid card.

At step 218, upon receiving the offer acceptance from the client device 102, or in the case of FIG. 8, submission of personal information, the remote server 104 and/or the card offer module 112 associates a unique identifier code with the offer for the personalized prepaid card. In some cases, the code may be a unique code generated for each user or prospective customer that accepts the offer 700 presented upon customizing the product 502. The card offer module 112 and/or the remote server 104 may store the unique identifier code in a memory of the remote server 104 in association with information to identify the user 108 (such as, e.g., a first and last name of the user 108) and/or information to identify the offer 700 (such as, e.g., a promotional code for the offer 700). At step 220, the remote server 104 sends the unique identifier code to the client device 102, and at step 222, the client device 102 displays the unique identifier code to the user 108 using the client interface 114.

In embodiments, the card offer module 112 can be configured to generate an eligibility certificate 900 that provides a unique identifier code 902 to the user 108, along with instructions to present the certificate 900 and the code 902 to the retail establishment 116 upon satisfying the predetermine condition(s) associated with the offer, for example, as shown in FIG. 9. The user 108 may present the eligibility certificate 900 at the retail establishment 116 by showing an electronic copy of the certificate 900 displayed on the client device 102 or by presenting a physical print-out of the certificate 900. The eligibility certificate 900 may be delivered to the user 108 in the form of an electronic message or email, a text message, a pop-up or other new window, an attachment or downloadable file included with any of the same, a letter, flyer, brochure, or other printed material, or any other type of message. FIG. 10 shows an exemplary message 904 that may be provided to the user 108 via the client device 102 and that comprises a link 906 for accessing or downloading the eligibility certificate 900. In embodiments, the eligibility certificate 900 can be automatically provided to the user 108 once he/she accepts the offer 700 or once he/she submits the personal information requested at the quote request window 800.

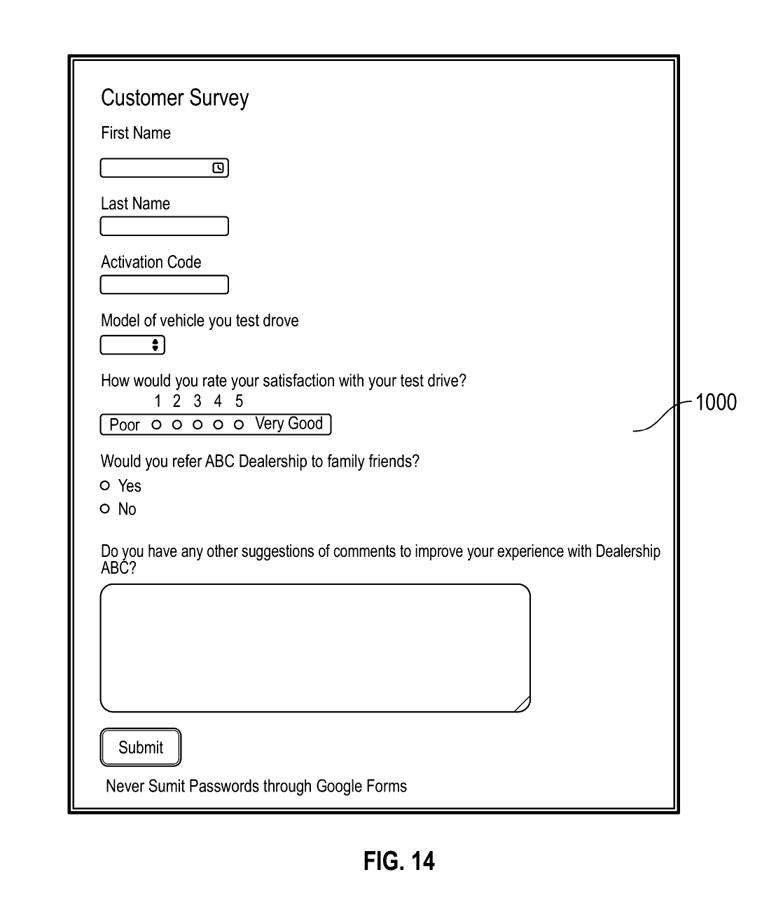

As shown, the eligibility certificate 900 (and in some cases, the message 904) displays the card image 706, as well as details about the offer, including the one or more conditions associated with the offer and a cash value to be loaded onto the personalized prepaid card upon completion of the one or more conditions. In embodiments, the personalized prepaid card has an initial cash value of zero, and the cash value to be loaded onto the personalized prepaid card can be any monetary amount (e.g., $10, $20, $50, etc.) that is predetermined by the product manufacturer and/or the retail establishment 116. Likewise, the one or more conditions can be predetermined by the product manufacturer and/or the retail establishment 116 and can include test-driving, testing, sampling, trying-on, or otherwise experiencing in-person the user-customized product 502 at a physical store or retail location that sells the product, such as, for example, the retail establishment 116. In some cases, the one or more conditions of the offer also include providing personal or contact information (such as, e.g., name, mailing address, telephone number, and email address) for example, as shown in FIG. 8, to enable the product manufacturer and/or retail establishment 116 to contact the user 108 to provide more information about the user-customized product 502 and other advertising purposes. In some cases, the one or more conditions further include completing a customer survey 1000 that is generated by the card offer module 112 and/or the remote server 104, and accessed via the client interface 114, for example, as shown in FIG. 14 and discussed in more detail below. As will be appreciated, other conditions may be associated with the offer and the disclosure is not limited to only those disclosed herein.

At step 224, the user 108 visits a physical retail location that sells the user-customized product 502, such as the retail establishment 116. If the predetermined condition(s) of the offer include testing, test-driving, or otherwise experiencing the user-customized product 502, at step 226, the user 108 also tests the user customized product 502 while at the retail establishment 116. At step 228, upon completing the testing of the user-customized product 502, the user 108 provides the unique identifier code 902 to a sales representative or other employee of the retail establishment 116 to redeem the offered prepaid card.

At step 230, the remote server 104 hosts the retail interface 118 for receiving confirmation that a predetermined condition of the offer 700 has been satisfied at the retail establishment 116. At step 232, the retail establishment 116, or an employee thereof, selects and displays the retail interface 118 on the retail device 106. At step 234, the employee of the retail establishment 116 enters the unique identifier code 902 provided by the user 108 into the retail interface 118. At step 236, the retail device 106 sends the code 902 entered via the retail interface 118 to the remote server 104. As an example, FIG. 11 shows a dealer dashboard 1100 for entering the unique identifier code 902, as well as other required information about the user 108, and submitting the same to the remote server 104.

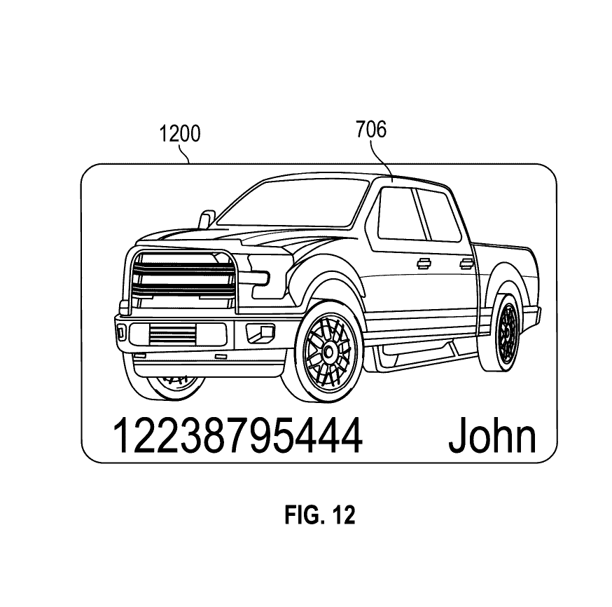

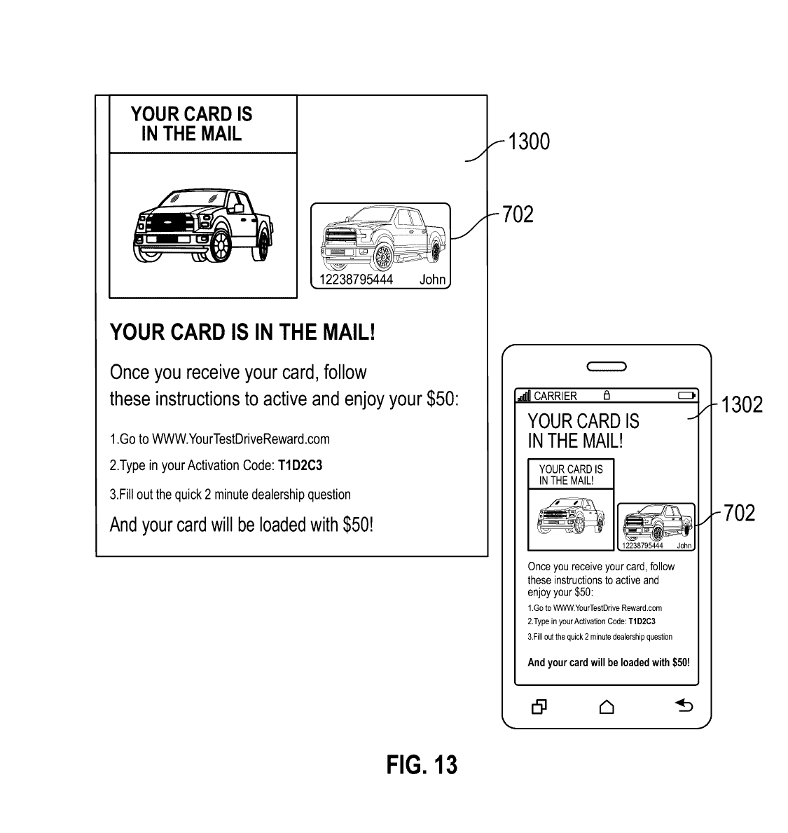

At step 238, the remote server 104 and/or the card offer module 112 validate the unique identifier code 902 received from the retail device 106 by comparing the received code with a unique identifier code stored in the memory of the remote server 104. At step 240, if the remote server 104 determines that the code is not valid, the remote server 104 sends an error message to the retail device 106, and at step 242, the retail device 106 displays the error message via the retail interface 118 to inform the retail establishment 116 that an incorrect or invalid code has been entered. In some cases, the offer 700 may have an expiration date, such that the unique identifier code 902 cannot be validated if entered after the expiration date, thus prompting the error message. At step 244, if the code is valid, the remote server 104 and/or the card offer module 112 activate a prepaid card (e.g., virtual, physical, or mobile payment device) that is personalized with an image of the user-customized product 502 and load the card with the predetermined cash value provided in the offer 700. As an example, FIG. 12 shows a physical prepaid card 1200 that has the second image 706 of the user-customized product 502 imprinted on a face of the card 1200.

At step 246, the remote server 104 provides instructions to send the personalized prepaid card 1200 to the user 108. In a preferred embodiment, the personalized prepaid card 1200 can have a zero cash value when the card is initially sent to the user 108 and can be loaded with funds only after all of the conditions of the offer have been met. According to embodiments, step 246 may occur at any point in the process 200 once the user 108 has accepted the offer and provided address information (e.g., mailing address or email address) that can be used to send the personalized prepaid card 1200 to the user 108. For example, the remote server 104 may perform step 246 once the offer acceptance is received from the client device 102 at step 216. In a preferred embodiment, step 246 is performed after step 218, so that the unique identifier code can be provided in the same mailer or email that is used to send the personalized prepaid card 1200 to the user 108.

The actual delivery method can differ between steps 248 and 250 depending on the type of prepaid card 1200. For example, in the case of a mobile payment device, the remote server 104 can send the personalized prepaid card 1200 to the client device 102, and at step 248, the client device 102 displays a digital or electronic representation of the personalized prepaid card 1200 via a mobile wallet interface of the client device 102. In the case of a virtual prepaid card, the remote server 104 can electronically deliver the personalized prepaid card 1200 to an email address of the user 108 (e.g., an email address provided via the request quote window 800) or use other electronic messaging address information provided to the remote server 104, and at step 248, the client device 102 can display the virtual personalized prepaid card 1200 via the client interface 114 or other user interface. In the case of a physical prepaid card, the remote server 104 can instruct the physical personalized prepaid card 1200 to be mailed to a mailing address of the user 108 (such as, e.g., a mailing address provided at the request quote window 800 shown in FIG. 8.) using a mail delivery service, and at step 250, the user 108 receives the physical card 1200 in the mail. In one embodiment, the personalized prepaid card 1200 may be handed to the user at the retail establishment 116 upon meeting the offer condition(s).

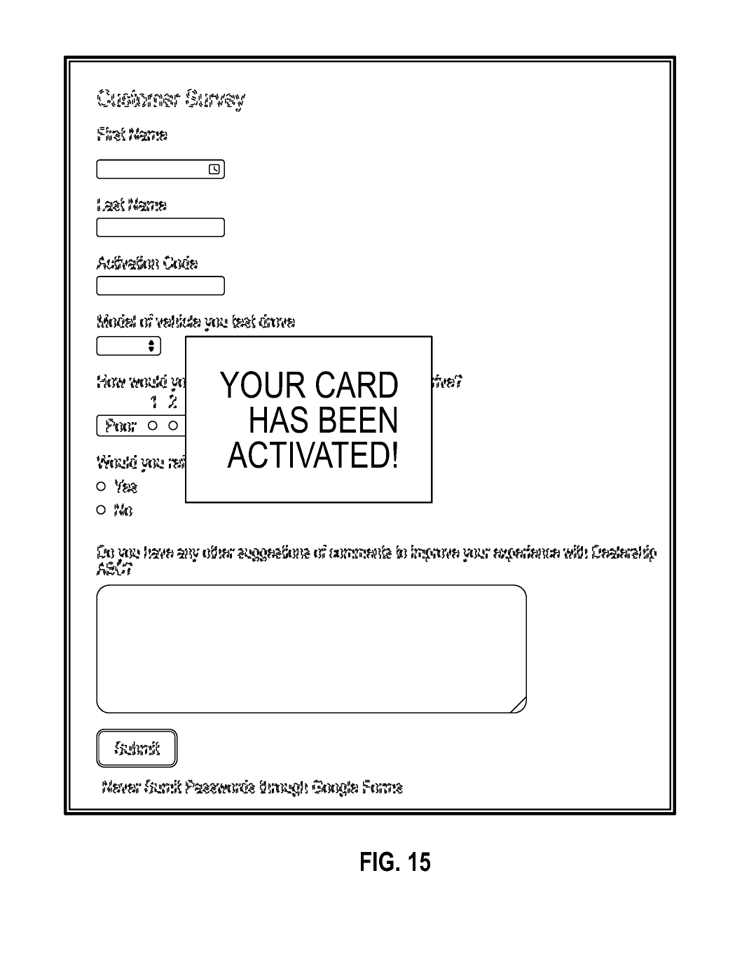

In some embodiments, before activation of the personalized prepaid card 120, the user 108 is asked to complete the customer survey 1000 shown in FIG. 14 as another condition of the offer 700. The customer survey 1000 can be a dealership survey to determine the quality of customer service and experience provided by the retail establishment 116. As shown in FIG. 13, the retail establishment 116 may provide the user 108 with instructions (e.g., via a paper flyer 1300 or an electronic message 1302) on how to satisfy the last condition of the offer 700. The instructions 1300/1302 include an activation code 1304 that is entered into a designated portion of the customer survey form as part of the customer survey 1000. As shown in FIG. 15, once the customer survey 1000 is properly submitted, the remote server and/or the card offer module 112 can activate the personalized prepaid card and load the card with the offered cash value.

In some embodiments, the remote server 104 and/or the card offer module 112 includes a card activation module 113 comprising computer modules or software instructions for generating an inactive prepaid card account upon receiving a signal, for example, from the retail device 106, indicating satisfaction of the one or more conditions associated with the card offer and upon determining that the unique identifier code is valid. In some cases, at step 238, the card activation module 113 determines whether the unique identifier code is valid and at step 244, the card activation module 113 activates the inactive prepaid card account if the code is valid and loads the card with the predetermined cash value. In other cases, the card activation module 113 may wait to activate the inactive prepaid card account until receiving a signal indicating that the survey 1000 has been completed. In some embodiments, the card activation module 113 is included in a server separate from the server that comprises the card offer module 112, for example, where the remote server 104 is implemented as a server network.

FIG. 3 illustrates an embodiment of a process 300 for providing a personalized prepaid card, in accordance with one or more embodiments. As an example, the process 300 may be carried out by a remote server (such as, e.g., the remote server 104 and/or one or more of the build-a-card module 110 and the card offer module 112 included therein), or any other entity, using software stored on a computer readable medium and executing on one or more computer processors (not shown) associated with the remote server 104 or other entity. The remote server may interact with one or more components of the system 100 to carry out certain operations of the process 300.

The process 300 may begin a step 302, where a processor receives user selections from a client device (such as, e.g., the client device 102) that is configured to enable a user (such as, e.g., the user 108) to design or build a user-configurable product. For example, via a client interface associated with the remote server (such as, e.g., the client interface 114), the user can interact with a website hosted by the remote server in order to input or enter information related to designing a customized product, including making selections with respect to customizable options for the product (e.g., an automotive vehicle). The user selections can be provided to, or received by, the remote server once the user has completed building the customized product.

The process 300 further includes step 304 where, based on the user selections and/or information received at step 302, the processor generates a card image showing a personalized prepaid card that comprises an image of the product, as customized by the user, displayed or printed on the card. At step 306, the processor sends, to the client device for display thereon, the card image and a user-selectable option to accept an offer providing the depicted personalized prepaid card in exchange for satisfying one or more conditions of the offer. In embodiments, the card image, the user-selectable option, and the associated offer can be displayed, on the client device, in a pop-up window or other new window that overlays, or is presented in conjunction with, the website hosted by the remote server.

At step 308, the processor determines whether the user has selected or accepted the offer. If the user does not select the user-selectable option within a pre-determined time period, or if the offer window is closed, the process 300 returns to the beginning, or step 302. If the user does select the user-selectable option or otherwise accepts the offer, at step 310 the processor provides the user with a unique identifier code that is associated with the offer. In embodiments, the processor generates a unique identifier code for the offer provided to the user and stores the code in a memory of the remote server in association with the offer and/or the user. The code can be sent to the user in a number of ways, including, for example, via email, text message, or paper mailer, or by displaying the code on the client device via the client interface. Along with the code, the processor also sends the user instructions on how to present the code to a physical retail location (e.g., the retail establishment 116) upon satisfying one or more conditions associated with the offer. For example, the user may be instructed to provide the unique identifier code to a physical retail establishment that sells the user-customized product, after testing, or test driving, the product.

The process 300 further includes, at step 312, sending the personalized prepaid card to the user, using at least one of physical/mail delivery and electronic delivery. For example, a physical (e.g., plastic) prepaid card can be mailed to a mailing address of the user, while a virtual (e.g., digital) prepaid card can be emailed, text messaged, or sent via social media to the user. The processor can be configured to send instructions to an appropriate entity (e.g., a card issuing entity, a card processor, the product manufacturer, a retail establishment, etc.) to mail the physical prepaid card to the user and/or to send the electronic message comprising the virtual prepaid card to the user. In some cases, the processor can also be configured to generate and send the electronic message. In some embodiments, the personalized prepaid card is sent to the user along with the unique identifier code, for example, in the same mailer or email message. In a preferred embodiment, at the time of sending the card, the personalized prepaid card has a zero cash balance, or no preloaded funds.

At step 314, the processor determines whether a code received from a retail device (e.g., the retail device 106), upon satisfaction of the predetermined condition(s) associated with the offer, matches the unique identifier code stored in the memory of the remote server. For example, in one embodiment, after testing the user-customized product at the retail establishment, the user provides the unique identifier code to a sales representative or other employee of the retail establishment, and said employee enters the code into a retail interface (e.g., the retail interface 118) hosted by the remote server. If the code received via the retail interface does not match the stored code, or is not valid, the processor sends an error message to the retail device at step 316. If, on the other hand, the entered code matches, or is valid, at step 318 the processor activates the personalized prepaid card. If the prepaid card has already been loaded with a cash value, the user can begin using the card once the card has been activated. In the case of a prepaid card that does not have a preloaded cash value, activation of the card may include loading the card with the previously-offered cash value. For example, if the user receives the personalized prepaid card (e.g., in the mail or via email) before satisfying the predetermined condition(s) associated with the offer, the card may remain inactivate and/or have a zero balance until the unique identifier code is received from the retail device and validated by the processor. In one embodiment, the prepaid card is loaded with a cash value once the user visits the retail establishment and the unique identifier code is entered into the retail interface, but the prepaid card remains inactive until the user completes a customer survey (e.g., the customer survey 1000 shown in FIG. 14), thus creating a two-step activation process.

FIG. 4 is a block diagram of an exemplary computing device 400 housing executable software used to facilitate the system 100. One or more instances of the computing device 400 may be utilized to implement any, some, or all of the components in the system 100, such as, for example, the remote server 104, the retail device 106, and/or the client device 102. Computing device 400 includes the memory element 404. Memory element 404 may include a computer readable medium for implementing the system 100, and/or components thereof, and for implementing particular system transactions. Memory element 404 may also be utilized to implement one or more databases 406. Computing device 400 also contains executable software, some of which may or may not be unique to the system 100.

In some embodiments, the system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 400 may be representative of any computer in which the system 100 resides or partially resides.

Generally, in terms of the hardware architecture as shown in FIG. 4, computing device 400 includes the processor 402, the memory 404, and one or more input and/or output (I/O) devices 406 (or peripherals) that are communicatively coupled via a local interface 408. Local interface 408 may be one or more buses or other wired or wireless connections, as is known in the art. Local interface 408 may have additional elements, which are omitted for simplicity, such as controllers, buffers (caches), drivers, transmitters, and receivers to facilitate external communications with other like or dissimilar computing devices. Further, local interface 408 may include address, control, and/or data connections to enable internal communications among the other computer components.

Processor 402 is a hardware device for executing software, particularly software stored in the memory 404. Processor 402 can be any custom made or commercially available processor, such as, for example, a Core series or vPro processor made by Intel Corporation, or a Phenom, Athlon or Sempron processor made by Advanced Micro Devices, Inc. In the case where computing device 400 is a server, the processor may be, for example, a Xeon or Itanium processor from Intel, or an Opteron-series processor from Advanced Micro Devices, Inc. Processor 402 may also represent multiple parallel or distributed processors working in unison.

Memory 404 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 404 can have a distributed architecture where various components are situated remote from one another, but are still accessed by processor 402. These other components may reside on devices located elsewhere on a network or in a cloud arrangement.

When computing device 400 is in operation, processor 402 is configured to execute software stored within memory 404, to communicate data to and from memory 404, and to generally control operations of computing device 400 pursuant to the software. The system 100, the process 200, and/or the process 300, in whole or in part, may be read by processor 402, buffered within processor 402, and then executed.

The software in memory 404 may include one or more separate programs. The separate programs comprise ordered listings of executable instructions for implementing logical functions. In the example of FIG. 4, the software in memory 404 may include one or more software applications 409 for executing the system 100, the process 200, and/or the process 300, in whole or in part, in accordance with the present disclosure, and a suitable operating system (O/S) (not shown). The operating system essentially controls the execution of other computer programs and provides scheduling, input-output control, file and data management, memory management, and communication control and related services. The type of operating system will depend on the type of computing device 400. Examples of suitable commercially available operating systems include Windows operating systems available from Microsoft Corporation, Mac OS X available from Apple Computer, Inc., a Unix operating system from AT&T, or a Unix-derivative such as BSD or Linux. If computing device 400 is an IBM PC compatible computer or the like, the software in memory 404 may further include a basic input output system (BIOS). The BIOS is a set of essential software routines that initialize and test hardware at startup, start the operating system, and support the transfer of data among the hardware devices. The BIOS is stored in ROM so that the BIOS can be executed when computing device 400 is activated.

Steps and/or elements, and/or portions thereof, of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, and Lua. Components of the system 100 may also be written in a proprietary language developed to interact with these known languages.

The I/O devices 406 may comprise one or more input devices 410, such as a keyboard, a mouse, a scanner, a microphone, a touch screen, a bar code reader, or an infra-red reader. The I/O devices 406 may also include output devices 412, such as a display, a printer, an audio speaker, a headphone port, or a projector. The I/O devices 406 may also comprise devices that communicate with the inputs or outputs, such as a communications module 414 comprising one or more of a short-range wireless communications transceiver (e.g., RFID, Bluetooth, etc.), a long-range wireless communications transceiver (e.g., WiFi, satellite,), a telephonic interface, a cellular communications port, a router, an Ethernet card, a wireless connection card, or other types of network communication equipment and circuitry. The I/O devices 406 may be internal to computing device 400, or may be external and connected wirelessly or via connection cable, such as through a universal serial bus port.

In a preferred network environment, each of the plurality of computing devices 400 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 400 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as infrared, radio frequency, Bluetooth, near field communication, and cellular networks.

In the context of this document, a “computer-readable medium” may be any means that can store, communicate, propagate, or transport data objects for use by or in connection with the system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. Portions of the system 100, the process 200, and/or the process 300 can be embodied in any type of non-transitory computer-readable medium for use by or in connection with an instruction execution system or apparatus, such as a computer.

Any process descriptions or blocks in figures, such as, e.g., the FIGS. 2 and 3, should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method of providing a personalized prepaid card, comprising:
receiving, from a client device associated with a user, user selections for designing a user-customized product;
based on the received user selections, generating with a processor a first image of a personalized prepaid card comprising a second image of the user-customized product;
sending to the client device the first image for display to the user, and sending a user-selectable option for accepting an offer to receive the personalized prepaid card in exchange for satisfying one or more conditions associated with the offer;
upon receiving a user selection of the user-selectable option, providing the user a unique identifier code associated with the offer and instructions to present the unique identifier code to a retail establishment selling the user-customized product upon satisfying the one or more conditions; and,
upon receiving the unique identifier code from a retail device associated with the retail establishment, activating the personalized prepaid card if the received unique identifier code is valid.

2. The method of claim 1, wherein the user-selectable option and the second image are presented on the client device after the user selects an option to request a price quote for the user-customized product.

3. The method of claim 1, wherein the user-selectable option and the second image are presented on the client device in a new application window, said new application window at least partially overlapping a main application window associated with designing the user-customized product.

4. The method of claim 1, further comprising:
providing, to the client device for display thereon, a prompt for entering personal information of the user which includes a delivery address, and
sending a message comprising the unique identifier code to said delivery address provided by entry of the personalized information.

5. The method of claim 4, wherein the delivery address is an email address and the message is an email message.

6. The method of claim 4, wherein the delivery address is a mailing address and the message is a printed material.

7. The method of claim 1, wherein the step of activating the personalized prepaid card includes loading the card with a predetermined cash value.

8. The method of claim 1, wherein the step of activating the personalized prepaid card includes:
providing an activation code to the user upon determining that the unique identifier code received from the retail device is valid; and
activating the personalized prepaid card once the activation code is received from the client device.

9. The method of claim 8, wherein the one or more conditions include completing a survey that requests entry of the activation code and customer feedback.

10. The method of claim 1, wherein the one or more conditions include visiting the retail establishment and testing the user-customized product.

11. The method of claim 10, wherein the retail establishment sells automotive vehicles, the user-customized product is a select configuration of one of said automotive vehicles, and the testing includes test-driving the select one of said automotive vehicles.

12. The method of claim 1, wherein the personalized prepaid card is a virtual prepaid card.

13. The method of claim 12, further comprising:
electronically delivering the virtual prepaid card to the user, using the processor.

14. The method of claim 1, wherein the personalized prepaid card is a physical prepaid card.

15. The method of claim 14, further comprising:
sending the physical prepaid card to the user via a mail delivery service.

16. The method of claim 1, further comprising:
providing the personalized prepaid card to the user upon receiving the user selection of the user-selectable option to accept the offer, the provided card remaining inactive until a valid unique identifier code is received by the processor from the retail device.

17. A system for providing a personalized prepaid card, comprising:
a remote server comprising a build-a-product module for enabling a user to select customizable options for designing a user-customized product;
a client device associated with the user and communicatively coupled to the remote server for providing user selections defining the user-customized product to the remote server,
wherein the remote server further comprises a card offer module for generating a first image of a personalized prepaid card with a second image of the user-customized product, the second image having an appearance based on the user selections received from the client device, the card offer module further being configured to send to the client the first image and a user-selectable option for accepting an offer to receive the personalized prepaid card in exchange for satisfying one or more conditions associated with the offer, the card offer module also configured to provide to the user a unique identifier code associated with the offer and instructions to present the unique identifier code to a retail establishment selling the user-customized product upon compliance with the one or more conditions; and
a retail device associated with the retail establishment and communicatively coupled to the remote server for providing to the remote server the unique identifier code received from the user,
wherein the card offer module is further configured to activate the personalized prepaid card if the received unique identifier code is valid.

18. The system of claim 17, wherein the personalized prepaid card is a virtual prepaid card.

19. The system of claim 17, wherein the personalized prepaid card is a physical prepaid card.

20. The system of claim 17, wherein the one or more conditions include a requirement for the user to visit a retail location.

21. The system of claim 17, wherein the user-selectable option and the second image are presented in a new application window on the client device at least partially overlapping a main application window associated with designing the user-customized product.

22. The system of claim 17, wherein the user-selectable option and the second image are presented on the client device upon user selection of an option to request a price quote for the user-customized product.

23. The system of claim 17, wherein the offer module is configured to activate the personalized prepaid card with a load of a predetermined cash value.

24. The system of claim 17, wherein the offer module is configured to activate the personalized prepaid card after the unique identifier code is received from the client device and determined to be valid.

25. The system of claim 24, wherein the one or more conditions include completing a survey that requests entry of the activation code and customer feedback.

26. The system of claim 17, wherein the card offer module is further configured to provide the personalized prepaid card to the user upon receipt of the user-selectable option to accept the offer, and the personalized prepaid card is inactive until a valid unique identifier code is received from the retail device.

27. A system for providing a personalized prepaid card, comprising:
a server network comprising a build-a-product module for receiving an electronic signal identifying a user-customized product having selected customized options for the product, the system further having a card-offer module for generating an image of a personalized prepaid card having an image of at least a portion of the user-customized product;
the system being configured to transmit said image of the personalized prepaid card with a conditional offer to deliver the personalized prepaid card in exchange for satisfying one or more conditions associated with the offer, and configured to transmit a unique identifier code associated with the offer; and
the system further comprising a card activation module for generating an active prepaid card account upon receiving a signal indicating satisfaction of said one or more conditions associated with the offer and upon determining that the unique identifier code is valid.

28. The system of claim 27, wherein said one or more conditions include a requirement for the user to visit a retail location.

29. The system of claim 27, wherein the card offer module is further configured to provide the personalized prepaid card to the user upon receipt of the user-selectable option to accept the offer, and the personalized prepaid card is inactive until a unique identifier code is determined to be valid.
